(19) United States
(12) Patent Application Publication
(10) Pub. No.: US 2015/0306820 A1
(43) Pub. Date: Oct. 29, 2015

(54) METHOD FOR MELTING POWDER, COMPRISING HEATING OF THE AREA ADJACENT TO THE BATH

(71) Applicant: MBDA FRANCE, LE PLESSIS ROBINSON (FR)

(72) Inventors: Christophe COLIN, Evry (FR); Jean-François FROMENTIN, Cesson (FR); Gérard SAUSSEREAU, Le Mesnil Saint Denis (FR)

(21) Appl. No.: 14/648,528

(22) PCT Filed: Nov. 29, 2013
(86) PCT No.: PCT/FR2013/052906

§ 371 Date: May 29, 2015

(30) Foreign Application Priority Data
Nov. 30, 2012 (FR) 1203258

(51) Int. Cl. B29C 67/00; B23K 26/30; B23K 26/34; B28B 1/00; H05B 6/10

(52) U.S. Cl. CPC B29C 67/0077; B28B 1/001; B29C 67/0085; H05B 6/101; B23K 26/345; B23K 26/422; B33Y 10/00

(57) ABSTRACT

A method for fabricating a part by melting powder with the help of a high energy beam uses a device that includes a building support for receiving at least one powder layer; a high energy beam generator suitable for raising particles of the powder to a temperature higher than their melting temperature T_{F}, and for forming a liquid pool including at least the particles of the melted powder, and an auxiliary heater device that is suitable for heating the material situated in a zone adjacent to the pool to a temperature that is lower than the melting temperature T_{F}, the zone including at least one region selected from an upstream region situated upstream from the pool and a downstream region situated downstream from the pool.

The present invention relates to the field of fabricating parts by melting powder by means of a high energy beam (laser beam, electron beam, . . . ).

The invention relates more particularly to a method comprising the following steps:

a) supplying a material in the form of powder particles;

b) heating a first quantity of the powder to a temperature higher than the melting temperature T_{F} of the powder with the help of a high energy beam, and forming, at the surface of a support, a first pool comprising the melted powder and a portion of the support;

c) heating a second quantity of the powder to a temperature higher than its melting temperature T_{F} with the help of the high energy beam, and forming, at the surface of the support, a second pool comprising the melted powder and a portion of the support downstream from the first pool;

d) repeating step c) until a first layer of the part is formed on the support;

e) heating an [n]^{th} quantity of the powder to a temperature higher than its melting temperature T_{F} with the help of a high energy beam, and forming an [n]^{th} pool comprising in part the melted powder above a portion of the first layer;

f) heating an [n+1]^{th} quantity of the powder to a temperature higher its melting temperature T_{F} with the help of the high energy beam, and forming an [n+1]^{th} pool comprising in part the melted powder downstream from said [n]^{th} pool above a portion of said first layer;

g) repeating step f) so as to form a second layer of the part above the first layer; and

h) repeating steps e) to g) for each layer situated above an already-formed layer until the part is substantially in its final shape.

In the above method, [n−1] quantities of powder are needed to form the first layer.

Methods are known that make it possible to obtain mechanical parts that are of complex three-dimensional (3D) shape. Those methods build up a part layer by layer until the shape desired for the part has been reconstituted. Advantageously, the part may be reconstituted directly from a computer-aided design and manufacturing (CADM) file deduced from processing the data of a 3D computer assisted design (CAD) graphics file, with a computer controlling the machine that thus forms successive layers of material that is melted and then solidified, one layer on another, with each layer being constituted by juxtaposed fillets of size and shape defined from the CADM file.

By way of example, the particles constituting the powder may be metallic, intermetallic, ceramic, or polymeric.

In the present application, when the powder is a metal alloy, the melting temperature T_{F} is a temperature lying between the liquidus temperature and the solidus temperature for the given composition of the alloy.

The building support may be a portion of some other part on which it is desired to add an additional function. Its composition may be different from that of the projected powder particles, and it may thus have a different melting temperature.

These methods include in particular projection by laser or “direct metal deposition” (DMD), “selective layer melting” (SLM), and “electron beam melting” (EBM).

The characteristics and the operation of DMD and SLM methods are summarized briefly below.

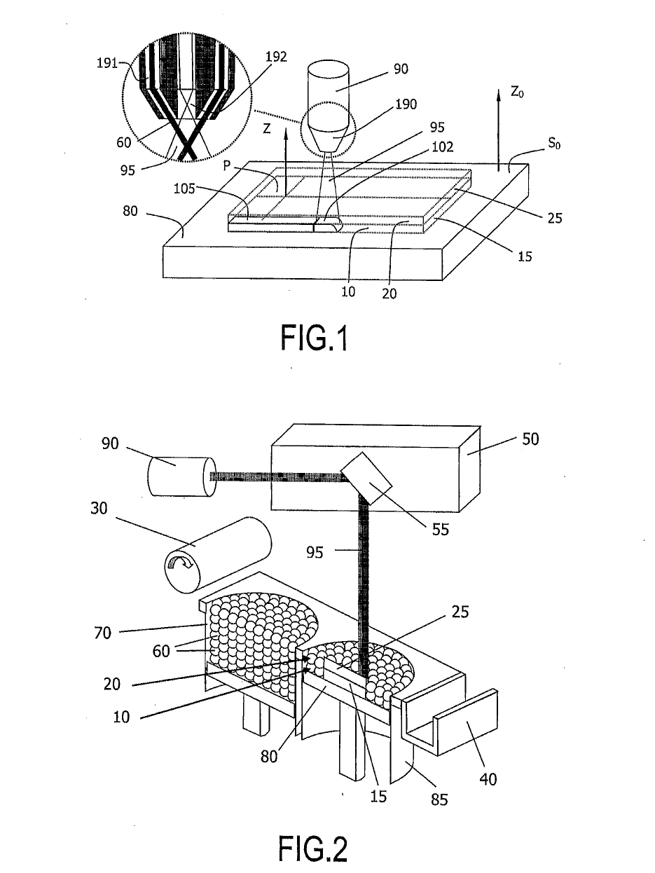

The operation of the DMD method is explained below with reference to FIG. 1.

A first layer 10 of material is formed, under local protection or within an enclosure at a regulated high or low pressure of inert gas, by projecting powder particles through a nozzle 190 onto the material on a support 80. Simultaneously with projecting particles 60 of powder, the nozzle 190 emits a laser beam 95 coming from a generator 90. The first orifice 191 of the nozzle 190 through which the powder is projected onto the support 80 is coaxial around the second orifice 192 through which the laser beam 95 is emitted, such that the powder is projected into the laser beam 95. The powder forms a cone of particles, the cone being hollow and presenting a certain thickness, and the laser beam is conical.

The laser beam 95 forms a pool 102 on the support 80 by melting the region of the support 80 that is exposed to the laser beam. The powder feeds the pool 102 in which it arrives already in the molten state, the powder being melted on its path in the laser beam prior to reaching the pool.

Alternatively, and by way of example, the nozzle 190 may be controlled and/or positioned in such a manner that the powder does not spend sufficient time in the laser beam 95 for all of the powder to be completely melted, and it melts on reaching the pool 102 as previously formed on the surface of the support 80 by melting the region of the support 80 that is exposed to the laser beam 95.

The powder could also not be melted at all by the laser beam 95, or could be melted in part only, because the size of some or all of the particles making up the powder is too great for them to melt.

While the laser beam 95 (or the support 80) moves downstream, the pool 102 is maintained and solidifies progressively to form a fillet of solidified material 105 on the support 80. The process is continued so as to form another solidified fillet on the support 80, this other fillet being juxtaposed with the first fillet, for example. Thus, by moving the nozzle 190 or the support 80 in a plane parallel to the working plane, a first layer 10 of material is deposited on the support 80, which layer forms by solidifying a first element 15 in a single piece of shape that complies with the shape defined in the CADM file. The working plane P is defined as being the plane containing the surface on which the layer is being built and/or formed.

Thereafter, the nozzle 190 and the laser beam 95 are caused to perform a second scan together so as to form in similar manner a second layer 20 of material on top of the first element 15. This second layer 20 forms a second consolidated element 25, and together these two elements 15 and 25 form a single-piece block. The pools 102 formed on the first element 15 during building of the second layer 20 generally comprise at least a portion of the first element 15 that has melted by being exposed to the laser beam 95, together with the particles of the powder feeding the pools 102.

Consideration is given to a reference frame constituted by a vertical axis Z₀ perpendicular to the surface S₀ of the support and by the surface of the support. This surface S₀ of the support is the plane at height zero. A plane contained in the support or beneath the surface S₀ (and perpendicular to the vertical axis Z₀) is of negative height, and a plane above the surface S₀ of the support (and perpendicular to the vertical axis Z₀) is at a positive height. A given plane is above another plane if it has a positive height that is greater than the height of that other plane.

In this reference frame, the second layer 20 is situated in a plane that is situated above the plane of the first layer 10.

For a layer in general, the working plane P is not necessarily parallel to the surface S₀. The axis Z defined as being perpendicular to the working plane P is thus not necessarily parallel to the axis Z₀. In general, the working plane of a higher layer need not be parallel to the working plane of the preceding lower layer, in which the axis Z of the higher layer is at a non-zero angle relative to the axis Z of the working plane of the lower layer, and the distance ΔZ measured along the latter axis Z above each point of the lower layer is a mean value.

This process of preparing the part layer by layer is then continued by adding additional layers over the assembly that has already been formed.

The movement of the support 80 or the scanning together of the nozzle 190 and the laser beam 95 enables each layer to be given a shape that is independent of the shape of the adjacent layers. The lower layers of the part are annealed and cool progressively while the higher layers of the part are being formed.

The operation of the SLM method is explained below with reference to FIG. 2.

The powder is made up of particles 60 arranged in a feed bin 70 having a bottom that is adjustable in height. A first layer 10 of powder of a material is deposited, e.g. with the help of a roller 30 (or any other deposition means) on a build support 80, which powder is transferred from the feed bin 70.

The build support 80 slides in a build bin 85, with the side walls of the build bin 85 serving to confine the powder laterally. The roller 30 also serves to spread, and possibly to compact, the powder on the build support 80 in successive passes. Excess powder is recovered in a recycling bin 40 situated adjacent to the build bin 85.

Thereafter, a region of the first layer 10 of powder is taken to a temperature higher than the melting temperature T_{F} of the powder, by being scanned with a laser beam 95 emitted by a generator 90.

The powder particles 60 in this region of the first layer 10 are thus melted and form a first single-piece element 15. During this stage, partial melting of the support 80 might also take place, thereby attaching it to the first element 15.

The support 80 is lowered through a height corresponding to the already-defined height for the first layer (in the range 20 micrometers (μm) to 100 μm, and generally in the range 30 μm to 50 μm). The thickness of the powder layer for melting remains a value that can vary from one layer to another since it depends strongly on the porosity of the bed of powder and on its planeness.

A second layer 20 of powder is deposited on the first layer 10 (using the above-defined reference frame).

Thereafter, a region of the second layer 20 is heated by exposure to the laser beam 95, which layer is situated at least in part on the first consolidated element 15, such that the powder particles in this region of the second layer 20 melt and form a second consolidated element 25, these two elements 15 and 25 as shown in FIG. 2 together forming a single-piece block when they solidify as a result of the first element 15 melting at least in part under the effect of the laser beam 95.

Depending on the profile of the part that is to be built, and in particular if it has an under-cut surface, it can happen that the above-mentioned region of the second layer 20 that is melted and then solidified does not touch the melted and solidified region of the first layer 10, such that the first consolidated element 15 and the second consolidated element 25 then do not form a single-piece block.

This process of building the part layer by layer is then continued by adding additional layers of powder above the assembly that has already been formed.

For parts of certain shapes, the region of one or more given layers scanned by the laser beam 95 may form a plurality of independent elements within that layer, these elements then being disjoint.

The region of a given layer may be constituted by the entire layer.

Scanning the laser beam 95 makes it possible to consolidate each layer while giving it a shape that matches the shape of the part to be made. The lower layers of the part cool while the higher layers of the part are being built.

This scanning of the laser beam 95 is performed by a control system. For example, in the SLM method, the control system 50 comprises one or more steerable mirrors 55 on which the laser beam 95 is reflected before it reaches a powder layer, with the angular position(s) of the mirror(s) 55 being controlled by galvanometer head means so that the laser beam scans a region of the powder layer, and thus follows the previously-established profile for the part. The galvanometer head means are controlled by the CADM file that is derived by processing CAD data of the part to be fabricated.

In the DMD method, the control system 50 (not shown in FIG. 1) moves the support 80 or the nozzle 190 and the laser beam 95 together.

The DMD method or the SLM method may use any high energy beam instead of the laser beam 95, so long as the beam has sufficient energy to melt the powder particles and a portion of the material under which the fillet of solidified material forms.

Nevertheless, the SLM and DMD methods present drawbacks.

All of the powder is brought to above its melting temperature T_{F} by direct exposure to the laser beam 95 or by entering the liquid pool heated or maintained by the laser beam 95 (indirect melting of the powder). The material of the melted powder is thus subjected to a cycle of temperature rise followed by cooling when the pool solidifies down to a so-called “anneal” temperature between its melting temperature T_{F} and ambient temperature.

The pool is heated very quickly since the laser beam 95 brings a large amount of energy to the material in a period of time that is very short.

The pool also cools very quickly, since heat is pumped out of the pool by the previously-formed layers under the pool that have already solidified, with these already solidified layers forming a solid block. Furthermore, in a length of time that is very short (inversely proportional to the scanning rate of the laser beam 95), the pool passes from an environment that is very hot because it is exposed to the laser beam, to an environment that is subjected to a temperature closer to ambient than to its melting temperature T_{F}, which is equivalent to quenching in air.

This rapid successive heating and cooling of portions of the part during building gives rise to stresses in the part or to deformations of the part, depending on its shape, its size, and its clamping. The term “clamping” is used to designate making use of a stiffener that serves to stiffen a thin portion of a part in order to avoid the thin portion deforming.

If the part being built is solid and therefore not very deformable, stresses accumulate within the part while it is being fabricated, these stresses being in the form of residual stresses or indeed of cracks if they exceed the breaking stress of the material. Later on, in service, if the operating temperature of the part is too high, then the part will deform as a result of its residual stresses relaxing.

If the part being built has walls that are thin with little clamping (i.e. having one of their dimensions that is small compared with the other two, and being free to move), then the stresses that are generated during the cooling of each pool have the effect of deforming the part while it is being built. Such deformation thus leads to a part being fabricated with shape and dimensional accuracy that are not as desired.

Furthermore, such deformations of the part can disturb its fabrication method. Specifically, given that the positions of the fillets of a layer depend on the CADM file deduced from processing CAD data for the part to be fabricated, which data represents the volume of the part, an upper layer runs the risk, for example, of not forming entirely above a lower layer, since the lower layer has deformed and moved relative to its position initially specified by the CADM file.

The present invention seeks to remedy these drawbacks.

The invention seeks to propose a method that makes it possible to reduce or even eliminate the stresses that are generated during the formation of pools induced by rapid heating and followed by sudden cooling of the pools.

This object is achieved by the fact that, at least while forming each of the pools 102, auxiliary heating is used to heat the material situated in a zone adjacent to the pool to a temperature lower than the melting temperature T_{F}, the zone comprising at least one region selected from the upstream region situated upstream (i.e. behind) the pool and the region situated downstream from (i.e. in front of) the pool.

By means of these provisions, the internal stresses generated in the part are smaller as a result of the less sudden heating and cooling of the material that forms the successive liquid pools of powder. This serves to avoid forming excessive residual stresses and cracks in the part.

Advantageously, the material is heated in the upstream region upstream from the pool so as to reduce the rate of cooling of the material to less than its natural rate of cooling.

This serves to avoid the material cooling too fast, which would generate residual stresses.

The invention also provides a device for fabricating a part by melting powder with the help of a high energy beam, the device comprising:
a building support for receiving at least one powder layer; and
a high energy beam generator suitable for raising particles of the powder to a temperature higher than their melting temperature T_{F}, and for forming a liquid pool comprising the particles of the melted powder.

According to the invention, the device further comprises an auxiliary heater device suitable for heating the material situated in a zone that is connected (adjacent) to the pool to a temperature lower than the melting temperature T_{F}, this zone comprising at least one region selected from the upstream region situated upstream from the pool and the downstream region situated downstream from the pool.

The invention can be well understood and its advantages appear better on reading the following detailed description of an embodiment given by way of non-limiting example. The description refers to the accompanying drawings, in which:

FIG. 1, described above, is a diagram for explaining the prior art method showing the device that is used with the DMD method;

FIG. 2, described above, is a diagram explaining the prior art method showing the device used in the SLM method;

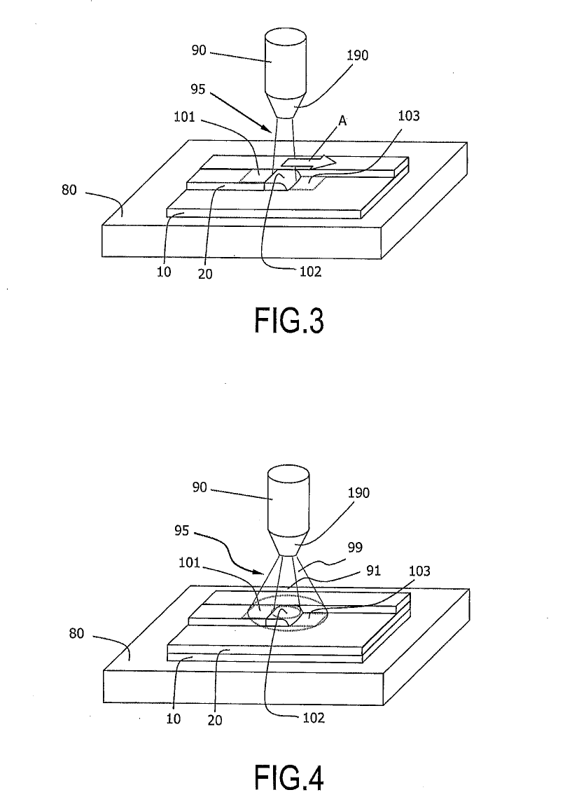

FIG. 3 is a diagram showing the positioning of upstream and downstream regions relative to the pool; and

FIG. 4 is a diagram showing the method of the invention when the DMD method is used.

In the description below, the beam used for melting the powder particles 60 is a laser beam 95. Nevertheless, in the DMD method or in the SLM method, any kind of high energy beam 95 can be used instead of the laser beam 95 so long as the high energy beam has sufficient energy to melt the powder particles and also a portion of the support or of lower layers.

In the description below, the terms “upstream” and “downstream” are defined relative to the travel direction of the liquid pool. This pool is fed with powder particles.

Thus, the laser beam 95 is positioned above the pool 102 that it has just formed in the surface of the part, either by heating the powder to a temperature higher than its melting temperature T_{F}, or by heating the surface of the part (with the powder particles then melting on coming into contact with the pool 102). The region 103 of the part that is adjacent to the pool 102 and that is going subsequently to be exposed to the laser beam 95 so as to be heated constitutes the region that is downstream relative to the pool 102, and the region 101 of the part that is connected to the pool 102 and that has just been exposed to the laser beam 95 and that is cooling down constitutes the region that is upstream relative to the pool 102.

The forward direction of the liquid pool 102 is thus from the (upstream) region 101 to the (downstream) region 103, with the forward direction of the pool being represented by arrow A going from left to right in FIG. 3.

FIG. 3 shows the positioning of these various regions in the context of the DMD method, at a stage when the second layer 20 is about to be deposited on a first device 10 that has already been deposited on the support 80. The positioning of these various regions is identical in the context of the SLM method, and regardless of which layer is being deposited.

In the context of the DMD method, it is either the nozzle 190 and the laser beam 95 together, or else the support 80 that is moved. In the context of the SLM method, it is the laser beam 95 that is moved.

In a first possibility of the invention, the material situated upstream from the pool 102, i.e. the material in the upstream region 101, is heated to below the melting temperature T_{F} of the powder particles 60 with the help of auxiliary heating.

This heating is performed at least while the pool 102 is being formed, i.e. while the pool is being heated. This auxiliary heating may also be continued after the pool 102 has formed.

This serves to prevent the material of the upstream region 101 from cooling too quickly. In other words, the rate of cooling of this region is reduced to less than its natural cooling rate (quenching in air or in some other gas, preferably an inert gas at the temperatures used in the pool). Consequently, the stresses that used to be generated by the material in this upstream region 101 cooling too quickly are reduced, or even eliminated.

In a second possibility of the invention, the material situated downstream from the pool 102, i.e. the material of the downstream region 103, is heated with the help of auxiliary heating to below the melting temperature T_{F} of the powder particles 60.

This heating is performed at least while the pool 102 is being formed, i.e. while the pool is being heated. This auxiliary heating may also begin earlier, i.e. before the pool 102 is formed.

In the context of the DMD method, the surface on which the powder particles 60 are going to be deposited later on by the nozzle 190 (when forming the following pool) is thus preheated.

In the context of the SLM method, the powder particles 60 in the downstream region 103 are preheated.

In both methods, since the downstream region 103 is already preheated when a new pool begins to form in this downstream region (which then becomes the new pool region 102), the rate at which this region heats up to the melting temperature T_{F} is slower than its natural heating rate (passing directly from ambient temperature to the temperature induced by the laser beam 95 in the absence of auxiliary heating), since the temperature of the material in this region is closer to the melting temperature T_{F} at the moment the laser beam 95 arrives and it is therefore subjected by the laser beam to heating that is not so fast in order to reach a temperature higher than the temperature T_{F}. Consequently, the stresses or cracks that used to be generated in the material of this downstream region 103 by this material being heated too quickly are reduced or even eliminated. This is particularly advantageous with materials that are sensitive to thermal shock on heating or when using materials of stiffness, toughness, or ductility that is low at temperatures closer to ambient than to the melting temperature T_{F}, or presenting a ductile-fragile transition at a temperature that is relatively high (about T_{F}/2). The ductile-fragile transition is defined as the temperature below which the material no longer accepts plastic deformation and passes directly from the elastic state to breaking.

It should be observed that in the invention, the heating of the zone adjacent to the pool 102 by auxiliary heating is performed in addition to the natural heating by conduction of heat coming from the pool 102. Furthermore, such natural heating takes place only in the immediate periphery of the pool 102 (thermally affected zone or TAZ) and is of an extent that is not sufficient for having any marked influence on the stresses generated in the part when forming pools 102 (see above).

Consequently, by means of the method of the invention, the stresses generated in the part when forming successive liquid pools 102 are reduced or even eliminated.

Furthermore, when the heating of the upstream region 101 by the auxiliary heating raises the upstream region 101 to a temperature close to the temperature T_{F}, the roughness (surface state) of the part is reduced. The term “temperature close to the temperature T_{F}” is used to mean a temperature lying in the range 0.9×T_{F} to T_{F}.

In the method of the invention, an auxiliary heater device is used to heat a zone that is adjacent to or connected to the pool 102 (i.e. touching the pool 102) and comprising a region selected from the upstream region 101 and the downstream region 103 relative to the pool 102. This zone may thus comprise the upstream region 101 on its own, or the downstream region 103 on its own, or both of these regions.

In addition to one or both of these regions, this zone may also include regions that are located laterally relative to the pool 102, and in particular in the same layer that is being built. The inventors have found that under such circumstances the auxiliary heating of the invention is more effective in reducing stresses within the part.

Advantageously, the adjacent zone heated by the auxiliary heating extends far enough away from the pool 102 in order to cover at least the region in which the pool preceding the pool 102 was situated and/or at least the region in which the pool following the pool 102 is to be situated.

Given that at least a portion of this zone adjacent to the pool is heated regardless of the position of the pool 102, the means for heating this zone move synchronously with the generator 90 of the laser beam 95.

The inventors have found that if the temperature to which the zone heated by the auxiliary heating lies in the range one-fourth to four-fifths of the melting temperature T_{F} of the powder, i.e. about T_{F}/4 to 4T_{F}/5, then stresses generated in the part while forming liquid pools 102 are minimized.

The inventors have found, advantageously, that this heating temperature may lie in the range T_{F}/3 to T_{F}/2, and depends amongst other things on the travel rate of the pool, on the power delivered by the laser beam, on the quantity of powder that is melted (and thus on the extent of the pool), and on the area over which the zone adjacent to the pool is to be heated.

When this adjacent zone comprises the downstream region 103, it is preferable for the heating temperature to be above the ductile-fragile transition temperature of the material of the powder so as to reduce any risk of it cracking by thermal shock (i.e. as a result of its temperature rising at high rate).

The zone adjacent to the pool 102 may be heated by using various heater devices.

For example, it is possible to heat the entire part by means of an oven in which the part and the support 80 are placed.

It is also possible to use a heater plate situated on the bottom face of the support 80 on which the part is built.

Advantageously, local heating may be performed around the liquid pool 102, i.e. solely in the zone adjacent to the liquid pool 102, with the heating applying to the upstream region 101 and/or to the downstream region 103.

By way of example, this local heating may be performed by induction, by means of an induction coil covering at least the upstream region 101 and/or the downstream region 103 and moving synchronously with the generator 90 of the laser beam 95.

This local heating may also be performed by a high energy beam that heats the zone adjacent to the liquid pool 102 to a temperature lower than the melting temperature T_{F}. Under such circumstances, this zone surrounds the pool 102 completely.

By way of example, the high energy beam is a second laser beam that is emitted by a second generator so that the second beam is preferably coaxial with the laser beam 95 that heats the liquid pool 102. The second laser beam may also be arranged laterally (i.e. not coaxially) relative to the first laser beam 95.

The second laser beam is either of lower power than the laser beam 95 that forms the liquid pool 102, or else of a different wavelength, or else it is unfocused so as to heat a sufficiently extensive area of the zone adjacent to the liquid pool 102 to a temperature that is lower than the melting temperature T_{F}.

Alternatively, the high energy beam is constituted by a peripheral portion 99 of the laser beam 95, which portion is unfocused. Thus, the central portion 91 of the laser beam 95 forms the liquid pool 102 possibly while also heating the powder particles, while the peripheral portion 99 of the laser beam 95 heats the zone around the liquid pool 102, including the upstream region 101 and the downstream region 103, to a temperature that is lower than the melting temperature T_{F}. This embodiment is shown in FIG. 4 for the DMD method.

This effect may also be obtained by a laser beam 95 having energy distribution (or power density distribution) that decreases with increasing distance from the center of the laser beam, such that the peripheral portion of the beam provides less heating than its central portion.

This solution presents the advantage of requiring only one laser beam 95 and thus only one laser beam generator 90.

In certain circumstances, it may be necessary to obtain a part without pores.

In the DMD and SLM methods, pores often form within the part and at the surface of the part. A distinction is drawn between open pores that are open to the outside and closed pores that are not open to the outside. As a general rule, open pores form as a consequence of an inappropriate choice of operating parameters and/or of a building strategy that is not adapted to the fillets and/or the layers. Closed pores preferably form as a result of gas occluded in the powder particles obtained by atomization, and/or gas (e.g. argon Ar) coming from the nozzle 190 or from the enclosure in which the part is being fabricated, which gas can become trapped in the pools when they cool quickly.

In order to eliminate closed pores, it is possible to perform hot isostatic pressing (HIP) after fabricating the part. The part is then placed in a gas enclosure and temperature and pressure in the enclosure are increased: this reduces the elastic limit of the material, thereby facilitating resorption of the closed pores under the effect of gas pressure. Certain pores disappear completely, but others merely reduce in diameter since the pressure inside those pores becomes equal to the applied pressure. Furthermore, during cooling and while eliminating the applied pressure, pores can burst, e.g. if they are too close to the free surface, thereby severely damaging the part.

Furthermore, gas-filled open pores remain present.

In order to eliminate open pores during fabrication of the part, a region is formed in each layer that is to form the surface (or skin) of the part with greater care than the remaining region that is to constitute the central portion of the part, such that the surface (or skin) of the part, once it has been formed, includes substantially no open pores.

This more careful formation is performed by scanning the region that is to be at the surface (or skin) of the part using a parameter that is different from the parameter used for the remaining region that is to be in the central portion of the part. This difference of parameter between the core and the outside of the part may be defined in the CADM file (for example, it may be a difference in the rate at which the laser beam is scanned).

Alternatively, or in addition, remelting is undertaken in certain zones of the outermost layer of the part where open pores are present together with some closed pores (e.g. pores that have not been resorbed by HIP), e.g. by scanning it with the laser beam. For example, the laser beam may raise the material in these zones to a temperature lying in the range one to one-and-a-half times the melting temperature of the material.

The temperature rise of the surface layer during this remelting allows material to flow, thereby smoothing the surface of the part and healing both open and closed pores. The open and closed pores that were still present at the surface are thus resorbed.

Thus, when the part is subsequently subjected to HIP treatment, the surface layer of the part acts as a leaktight skin and this facilitates resorption of closed pores present in the more central portion of the part. After HIP treatment, the part includes few or no closed pores and no open pores.

1. A method of fabricating a part, the method comprising:
a) supplying a material in the form of powder particles;
b) heating a first quantity of said powder to a temperature higher than a melting temperature of the powder with the help of a high energy beam, and forming, at a surface of a support, a first pool comprising the melted powder and a portion of the support;
c) heating a second quantity of said powder to a temperature higher than the melting temperature with the help of said high energy beam, and forming, at the surface of the support, a second pool comprising the melted powder and a portion of the support downstream from the first pool;
d) repeating step c) until a first layer of said part is formed on said support;
e) heating an [n]^{th} quantity of said powder to a temperature higher than the melting temperature with the help of a high energy beam, and forming an [n]^{th} pool comprising in part the melted powder above a portion of said first layer;
f) heating an [n+1]^{th} quantity of said powder to a temperature higher the melting temperature with the help of said high energy beam, and forming an [n+1]^{th} pool comprising in part the melted powder downstream from said [n]^{th} pool above a portion of said first layer;
g) repeating step f) so as to form a second layer of said part above said first layer; and
h) repeating steps e) to g) for each layer situated above an already-formed layer until said part is substantially in its final shape;
wherein, at least while forming each of the pools, auxiliary heating is used for heating the material situated in a zone adjacent to said pool, said zone comprising at least one region selected from an upstream region situated upstream from said pool and a downstream region situated downstream from said pool, to a temperature lying in the range one-fourth and four-fifths of said melting temperature.

2. A method according to claim 1, wherein the material in said upstream region situated upstream from said pool is heated so as to reduce a rate of cooling of said material to less than its natural rate of cooling.

3. A method according to claim 1, wherein the material in said downstream region situated downstream from said pool is heated so as to reduce a rate of heating of the material to below its natural rate of heating up to said melting temperature.

4. A method according to claim 1, wherein the material situated in at least a portion of said zone adjacent to the pool is heated to a temperature lying in the range one-third to one-half of said melting temperature.

5. A method according to claim 1, wherein said material is heated using a heater selected from the group consisting of an oven, a heater plate, an induction coil, and a high energy beam.

6. A method according to claim 1, wherein said material is heated using an unfocused portion of said high energy beam.

7. A method according to claim 1, further comprising, after step h), using a high energy beam to remelt certain zones of an outermost layer of said part so as to resorb open pores that are present and certain closed pores formed at a surface of said part.

8. A method according to claim 7, further comprising, after said remelting, performing hot isostatic pressing on said part so as to resorb the pores in said part.

9. A method according to claim 1, further comprising, after step h), forming the region in each layer that is to form a surface of said part in such a manner that the surface of the part, once formed, does not include any open or closed pores.

10. A device for fabricating a part by melting powder with the help of a high energy beam, the device comprising:
a building support for receiving at least one powder layer;
a high energy beam generator suitable for raising particles of the powder to a temperature higher than their melting temperature, and for forming a liquid pool comprising at least the particles of the melted powder, and
an auxiliary heater device that is suitable for heating the material situated in a zone adjacent to said pool to a temperature that is lower than said melting temperature, said zone comprising at least one region selected from an upstream region situated upstream from said pool and a downstream region situated downstream from said pool.
